(19) United States
(12) Patent Application Publication
(10) Pub. No.: US 2011/0187704 A1
(43) Pub. Date: Aug. 4, 2011

(54) GENERATING AND DISPLAYING TOP-DOWN MAPS OF RECONSTRUCTED 3-D SCENES

(75) Inventors: Billy Chen, Bellevue, WA (US); Eyal Ofek, Redmond, WA (US); Gonzalo Alberto Ramos, Bellevue, WA (US); Jonathan Robert Dughi, Bainbridge Island, WA (US); David Maxwell Gedye, Seattle, WA (US)

(73) Assignee: Microsoft Corporation, Redmond, WA (US)

(21) Appl. No.: 12/699,902

(22) Filed: Feb. 4, 2010

(51) Int. Cl. G06T 15/00

(52) U.S. Cl. 345/419

(57) ABSTRACT

Technologies are described herein for generating and displaying top-down maps of reconstructed structures to improve navigation of photographs within a 3-D scene. A 3-D point cloud is computed from a collection of photographs of the scene. A top-down map is generated from the 3-D point cloud by projecting the points in the point cloud into a two-dimensional plane. The points in the projection may be filtered and/or enhanced to enhance the display of the top-down map. Finally, the top-down map is displayed to the user in conjunction with or as an alternative to the photographs from the reconstructed structure or scene.

### BACKGROUND

Using the processing power of computers, it is possible to create a visual reconstruction of a scene or structure from a collection of digital photographs (“photographs”) of the scene. The reconstruction may consist of the various perspectives provided by the photographs coupled with a group of three-dimensional (“3-D”) points computed from the photographs. The 3-D points may be computed by locating common features, such as objects or textures, in a number of the photographs, and using the position, perspective, and visibility or obscurity of the features in each photograph to determine a 3-D position of the feature. The visualization of 3-D points computed for the collection of photographs is referred to as a “3-D point cloud.” For example, given a collection of photographs of a cathedral from several points of view, a 3-D point cloud may be computed that represents the cathedral's geometry. The 3-D point cloud may be utilized to enhance the visualization of the cathedral's structure when viewing the various photographs in the collection.

Current applications may allow a user to navigate a visual reconstruction by moving from one photograph to nearby photographs within the view. For example, to move to a nearby photograph, the user may select a highlighted outline or “quad” representing the nearby photograph within the view. This may result in the view of the scene and accompanying structures being changed to the perspective of the camera position, or “pose,” corresponding to the selected photograph in reference to the 3-D point cloud. This form of navigation is referred to as “local navigation.”

Local navigation, however, may be challenging for a user. First, photographs that are not locally accessible or shown as a quad within the view may be difficult to discover. Second, after exploring a reconstruction, the user may not retain an understanding of the environment or spatial context of the captured scene. For example, the user may not appreciate the size of a structure captured in the reconstruction or have a sense of which aspects of the overall scene have been explored. Furthermore, since the photographs likely do not sample the scene at a regular rate, a local navigation from one photograph to the next may result in a small spatial move or a large one, with the difference not being easily discernable by the user. This ambiguity may further reduce the ability of the user to track the global position and orientation of the current view of the reconstruction.

It is with respect to these considerations and others that the disclosure made herein is presented.

### SUMMARY

Technologies are described herein for generating and displaying top-down maps of reconstructed structures to improve navigation of photographs within a 3-D scene. Utilizing the technologies described herein, a top-down map or view of the 3-D point cloud computed from a collection of photographs of the scene may be generated and displayed to a user. The top-down map may also provide the user an alternative means of navigating the photographs within the reconstruction, enhancing the user's understanding of the environment and spatial context of the scene while improving the discoverability of photographs not easily discovered through local navigation.

According to one embodiment, the 3-D point cloud is computed from the collection of photographs. A top-down map is generated from the 3-D point cloud by projecting the points in the point cloud into a two-dimensional plane. The points in the projection may be filtered and/or enhanced to enhance the display of the top-down map. Finally, the top-down map is displayed to the user in conjunction with or as an alternative to the photographs from the reconstructed structure or scene.

It should be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing aspects of an illustrative operating environment and several software components provided by the embodiments presented herein;

FIG. 2 is a display diagram showing an illustrative user interface for displaying a top-down map generated from a 3-D point cloud computed for a collection of photographs, according to one embodiment presented herein;

FIG. 3 is a display diagram showing another illustrative user interface for displaying a top-down map generated from the 3-D point cloud, according to another embodiment presented herein;

FIG. 4 is a display diagram showing a top-down map displayed with associated reconstruction elements, according to embodiments described herein;

FIG. 5 is a display diagram showing a technique of displaying a thumbnail image and an associated camera pose based on a selection of points in the top-down map, according to one embodiment described herein;

FIG. 6 is a display diagram showing a technique of reflecting a thumbnail image so that it does not appear off-screen, according to another embodiment described herein;

FIG. 7 is a diagram showing a technique of filtering the points of the 3-D point cloud for inclusion in the top-down map, according to one embodiment described herein;

FIGS. 8A and 8B are diagrams showing another technique of filtering the points of the 3-D point cloud for inclusion in the top-down map, according to another embodiment described herein;

FIG. 9 is a diagram showing a technique of enhancing the display of the top-down map by detecting edges in the 3-D point cloud, according to one embodiment described herein;

FIG. 10 is a diagram showing another technique of enhancing the display of the top-down map by splatting points in the 3-D point cloud along a line, according to another embodiment described herein;

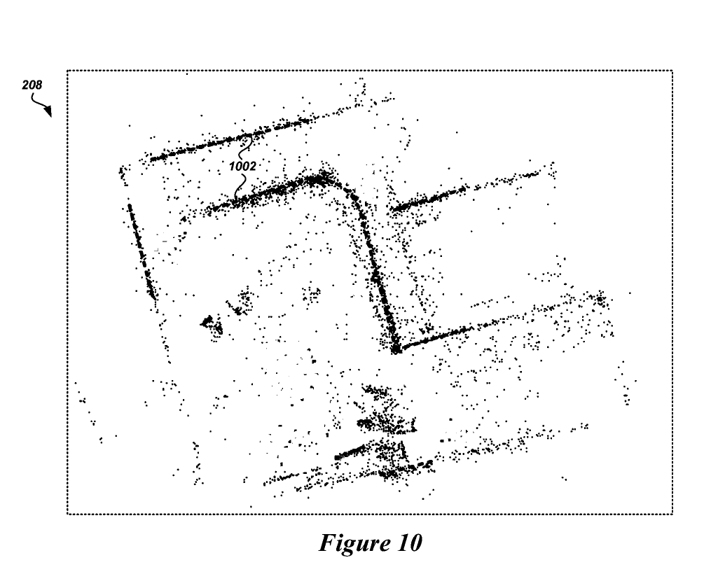

FIG. 11 is a display diagram showing a technique of visualizing multiple top-down maps of separate but related visual reconstructions, according to one embodiment described herein;

FIG. 12 is a flow diagram showing methods for generating and displaying top-down maps of reconstructed structures within a 3-D scene, according to embodiments described herein; and

FIG. 13 is a block diagram showing an illustrative computer hardware and software architecture for a computing system capable of implementing aspects of the embodiments presented herein.

### DETAILED DESCRIPTION

The following detailed description is directed to technologies for generating and displaying top-down maps of reconstructed structures to improve navigation of photographs within a 3-D scene. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof and that show, by way of illustration, specific embodiments or examples. In the accompanying drawings, like numerals represent like elements through the several figures.

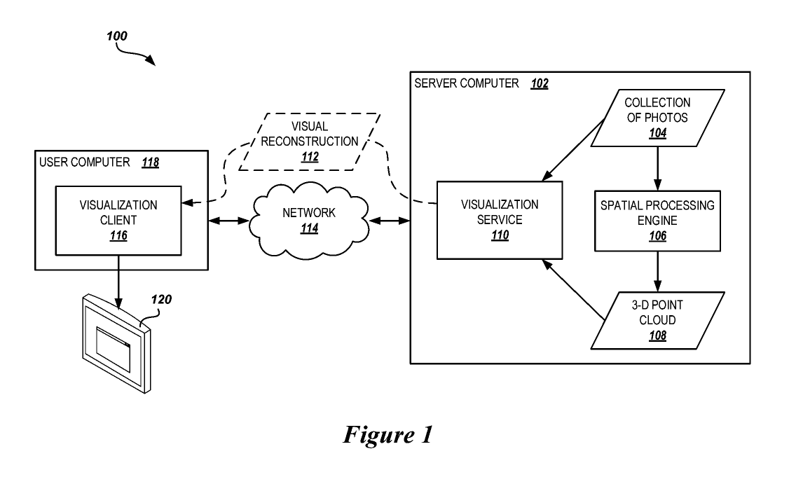

FIG. 1 shows an illustrative operating environment 100 including several software components for generating and displaying top-down maps from 3-D point clouds computed for a collection of photographs, according to embodiments provided herein. The environment 100 includes a server computer 102. The server computer 102 shown in FIG. 1 may represent one or more web servers, application servers, network appliances, dedicated computer hardware devices, personal computers (“PC”), or any combination of these and/or other computing devices known in the art.

According to one embodiment, the server computer 102 stores a collection of photographs 104. The collection of photographs 104 may consist of two or more digital photographs taken by a user of a particular structure or scene, or the collection of photographs may be an aggregation of several digital photographs taken by multiple photographers of the same scene, for example. The digital photographs in the collection of photographs 104 may be acquired using digital cameras, may be digitized from photographs taken with traditional film-based cameras, or may be a combination of both.

A spatial processing engine 106 executes on the server computer 102 and is responsible for computing a 3-D point cloud 108 representing the structure or scene from the collection of photographs 104. The spatial processing engine 106 may compute the 3-D point cloud 108 by locating recognizable features, such as objects or textures, that appear in two or more photographs in the collection of photographs 104, and calculating the position of the feature in space using the location, perspective, and visibility or obscurity of the features in each photograph. The spatial processing engine 106 may be implemented as hardware, software, or a combination of the two, and may include a number of application program modules and other components on the server computer 102.

A visualization service 110 executes on the server computer 102 that provides services for users to view and navigate visual reconstructions of the scene or structure captured in the collection of photographs 104. The visualization service 110 may be implemented as hardware, software, or a combination of the two, and may include a number of application program modules and other components on the server computer 102.

The visualization service 110 utilizes the collection of photographs 104 and the computed 3-D point cloud 108 to create a visual reconstruction 112 of the scene or structure, and serves the reconstruction over a network 114 to a visualization client 116 executing on a user computer 118. The user computer 118 may be a PC, a desktop workstation, a laptop, a notebook, a mobile device, a personal digital assistant (“PDA”), an application server, a Web server hosting Web-based application programs, or any other computing device. The network 114 may be a local-area network (“LAN”), a wide-area network (“WAN”), the Internet, or any other networking topology that connects the user computer 118 to the server computer 102. It will be appreciated that the server computer 102 and user computer 118 shown in FIG. 1 may represent the same computing device.

The visualization client 116 receives the visual reconstruction 112 from the visualization service 110 and displays the visual reconstruction to a user of the user computer 118 using a display device 120 attached to the computer. The visualization client 116 may be implemented as hardware, software, or a combination of the two, and may include a number of application program modules and other components on the user computer 118. In one embodiment, the visualization client 116 consists of a web browser application and a plug-in module that allows the user of the user computer 118 to view and navigate the visual reconstruction 112 served by the visualization service 110.

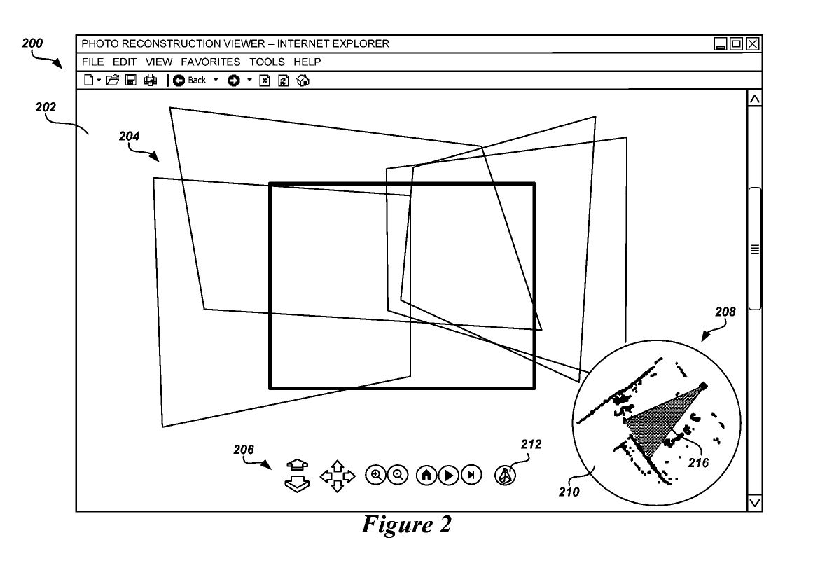

FIG. 2 shows an example of an illustrative user interface 200 displayed by the visualization client 116. The user interface 200 includes a window 202 in which a local-navigation display 204 is provided for navigating between the photographs in the visual reconstruction 112. The local-navigation display 204 may include a set of navigation controls 206 that allows the user to pan and zoom the photographs as well as move between them.

According to embodiments, the visual reconstruction 112 includes a top-down map 208 generated from the 3-D point cloud 108. Generally, the top-down map 208 is a two-dimensional view of the 3-D point cloud 108 from the top. The top-down map 208 may be generated by projecting all the points of the 3-D point cloud 108 into a two-dimensional plane, for example. The positions of the identifiable features, or points, computed in the 3-D point cloud 108 may be represented as dots in the top-down map 208. The top-down map 208 may be rendered using a perspective projection of the 3-D point cloud 108 from the point-of-view in the center of the top-down map, or an orthographic projection, like that found in many cartographical maps.

In another embodiment, the top-down map 208 may be rendered from photographs in the collection of photographs 104 or aerial images of the 3-D scene obtained from geo-mapping services, in addition to or as an alternative to the two-dimensional projection of the 3-D point cloud. In a further embodiment, the top-down map 208 may be rendered by projection of the 3-D point cloud onto a two-dimensional plane in some other orientation than a horizontal surface. For example, a top-down map may be projected onto a vertical two-dimensional plane for visualization of a building façade, or a curved manifold, such as a 360-degree cylinder, for visualization the interior of a room.

In one embodiment, the top-down map 208 is displayed in conjunction with the local-navigation display 204. This type of view is referred to as a “split-screen view.” For example, the window 202 may be split horizontally or vertically with the top-down map 208 displayed in one side of the split and the local-navigation display 204 in the other. In another example, the top-down map 208 may be displayed in an inset window, or “mini-map” 210, as shown in FIG. 2. The display of the mini-map 210 may be toggled by a particular control 212 in the navigation controls 206, for example.

According to one embodiment, the orientation of the top-down map 208 may be absolute and remain fixed according to an arbitrary “up” direction. The camera position and orientation of the current photograph being viewed in local-navigation display 204 may be indicated in the top-down map with a view frustum 216, as further shown in FIG. 2. In another embodiment, the orientation of the top-down map 208 may be relative, with the map rotated as the user navigates between the photographs in the local-navigation display 204 so that the map remains oriented in a view-up orientation.

In the split-screen view, a user may quickly obtain local and global information. The split-screen view also enables scenarios such as showing a user's path history on the top-down map 208 as the user explores the photographs in the visual reconstruction 112. However, in the split-screen view, the top-down map 208 may take away significant screen space from the local-navigation display 204 and may occlude a portion of the photographs. This constraint may be important when the window 202 is small, for example, such as in an embedded control in a web page.

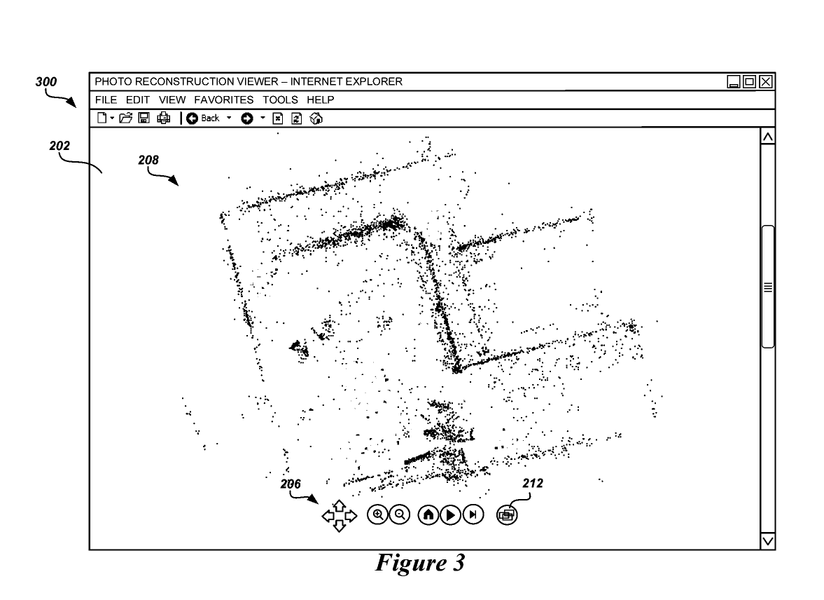

FIG. 3 shows another illustrative user interface 300 for displaying the top-down map 208 by the visualization client 116. In this example, the top-down map 208 is displayed separately from the local-navigation display 204. This view is referred to as the “modal view.” The visualization client 116 may provide a similar set of navigation controls 206 as those described above that allows the user to pan and zoom the top-down map 208 to reveal the entire scene or structure represented in the visual reconstruction 112, or to see more detail of a particular section. The user may toggle back and forth between the modal view of the top-down map 208 and the local-navigation display 204 using the particular control 212 in the navigation controls 206, for example.

Just as described above in the split-screen view, the orientation of the top-down map 208 in the modal view may be absolute and remain fixed according to an arbitrary “up” direction. A top-down map 208 with absolute orientation enjoys the property that a user may more easily understand the spatial context of the visual reconstruction 112. Alternatively, the orientation of the top-down map 208 in the modal view may be relative, with the map rotated to a view-up orientation in regard to the last viewed photograph in the local-navigation display 204. A top-down map 208 with relative orientation may enjoy simpler transitions between the map and photograph as the user toggles back and forth between the modal view of the top-down map and the local-navigation display 204. In a further embodiment, the top-down map 208 may be rotated manually by the user, utilizing another control (not shown) in the navigation controls 206, for example.

In the modal view, the top-down map 208 can be displayed using the entire screen space, and there may be less of a problem with split attention of the user between the photographs and the map. However, being modal in nature, the user may find it difficult to perform tasks that require quickly switching between the top-down map 208 and the local-navigation display 204.

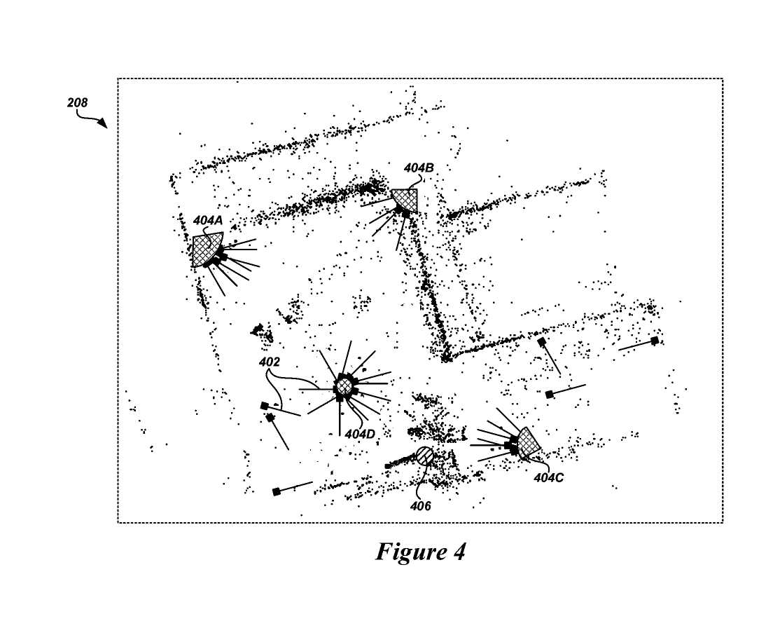

FIG. 4 illustrates one view of a top-down map 208 generated from the 3-D point cloud 108, including a number of reconstruction elements displayed in conjunction with the map. The visualization client 116 may receive the reconstruction elements from the visualization service 110 as part of the visual reconstruction 112. The visualization client 116 may then display these reconstruction elements overlaid on the top-down map 208. The reconstruction elements may include the position and orientation of the camera, or “camera pose,” for some or all of the photographs in the visual reconstruction 112. The visualization client 116 may indicate the camera poses by displaying camera pose indicators 402 on the top-down map 208. The camera pose indicators 402 show the position of the camera as well as the direction of the corresponding photograph. The camera pose indicators 402 may be displayed as vectors, view frusta, or any other graphic indicators.

The reconstruction elements may further include panoramas. Panoramas are created when photographs corresponding to a number of camera poses can be stitched together to create a panoramic or wide-field view of the associated structure or scene in the visual reconstruction 112. The panoramas may be included in the collection of photographs 104 intentionally by the photographer, or may be created inadvertently by any number of photographers contributing photographs to the collection of photographs. The visualization client 116 may display panorama indicators 404A-404D (referred to herein generally as panorama indicator 404) at the position of the resulting panoramic view. The panorama indicators 404 may be arcs that indicate the viewable angle of the associated panorama, such as the panorama indicators 404A-404C shown in FIG. 4. Similarly, a panorama with a 360 degree field of view may be represented with a circle, such as the panorama indicator 404D.

The reconstruction elements may also include objects which identify features or structures in the visual reconstruction 112 that the user can “orbit” by navigating through a corresponding sequence of photographs. The object may be identified by the visualization service 110 from a recognition of multiple angles of the object within the collection of photographs 104. The visualization client 116 may display an object indicator 406 at the position of the object on the top-down map 208.

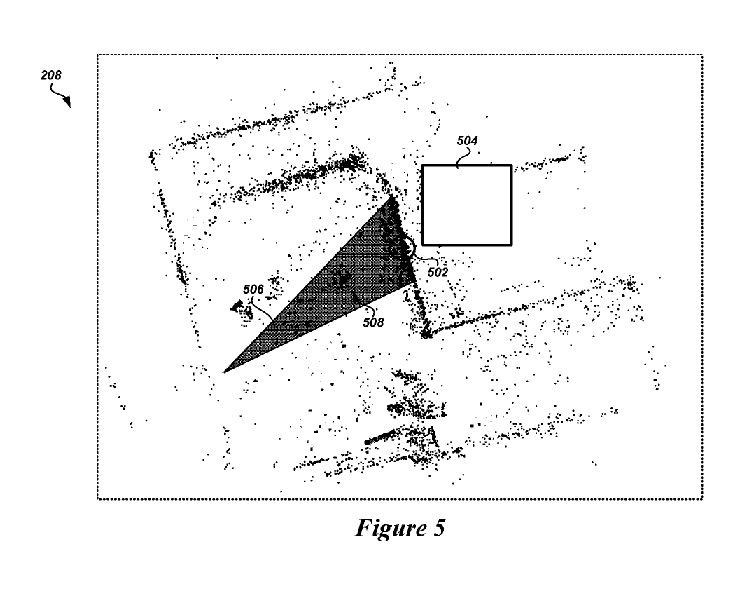

FIG. 5 illustrates another view of a top-down map 208 showing a technique of displaying thumbnail images of photographs on the map, according to embodiments. The visualization client 116 may provide the user with a selection control 502 that allows the user to select a position on the top-down map 208. The selection control 502 may be a circle, square, pointer, or other iconic indicator that the user may move around the map using a mouse or other input device connected to the user computer 118. According to one embodiment, when the user hovers the selection control 502 over a point or group of points on the top-down map 208, the visualization client 116 may display one or more thumbnail images 504 on the map. The thumbnail images 504 may correspond to photographs in the collection of photographs 104 in which the features corresponding to the selected points are visible.

In addition to the thumbnail images 504, the visualization client 116 may further display view frusta 506 or other indicators on the top-down map 208 that indicate the position and point-of-view of the cameras that captured the photographs corresponding to the thumbnail images. The location of the thumbnail images 504 on the top-down map 208 may be determined using a number of different techniques. For example, the thumbnail images 504 may be placed near the position of the camera that captured the corresponding photographs, or the thumbnail images may be placed near the selected points on the top-down map 208. In addition, the thumbnail images 504 may be placed along the projected line from the camera position through the selected points, as shown in FIG. 5.

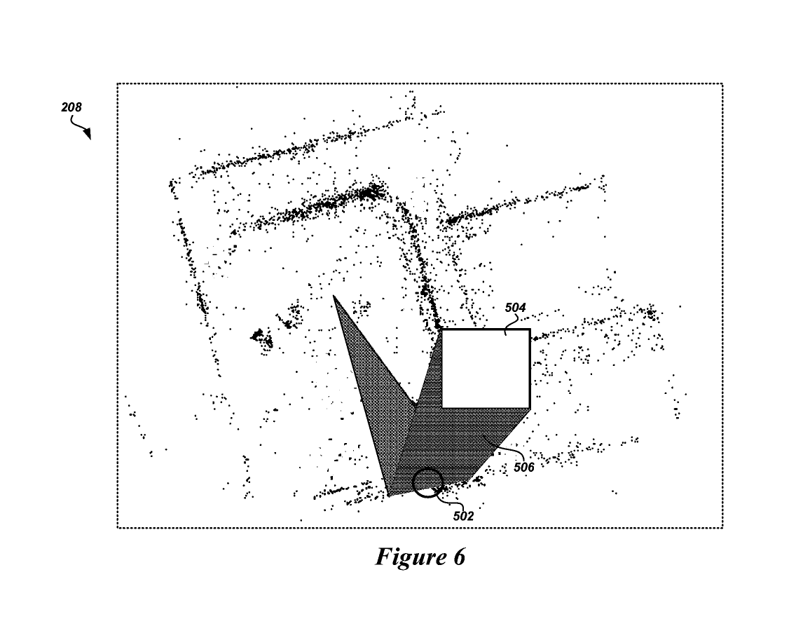

If the determination of the location of a thumbnail image 504 would result in the thumbnail being positioned off-screen, the visualization client 116 may reflect the thumbnail image to a location on-screen by altering the display of the view frustum 506, as shown in FIG. 6. Alternatively, the thumbnail image 504 may be projected onto the edge of the top-down map 208 and a strip or arrow may be rendered at that location. When a user zooms the top-down map 208 in the window 202, the size of the displayed thumbnail images 504 may be enlarged or reduced accordingly, or the thumbnail images may be displayed at a consistent size regardless of the zoom-level of the top-down map.

According to another embodiment, when the user hovers the selection control 502 over a position in the top-down map 208, the visualization client 116 may display one or more thumbnail images 504 on the map corresponding to photographs taken by cameras located in proximity to the selected position. In a further embodiment, only one thumbnail image 504 is displayed at a time, and the displayed thumbnail image may change as the user moves the selection control 502 about the top-down map 208. This provides for a less cluttered display, especially if the visual reconstruction 112 contains hundreds of photographs. If a number of photographs in the collection of photographs 104 contain the features corresponding to the selected points or were taken by cameras located in proximity to the selected position, the visualization client 116 may determine the best photograph for which to display the thumbnail image 504 by using a process such as that described in co-pending U.S. patent application Ser. No. 99/999,999 filed concurrently herewith, having Attorney Docket No. 327937.01, and entitled “Interacting With Top-Down Maps Of Reconstructed 3-D Scenes,” which is incorporated herein by reference in its entirety.

As further shown in FIG. 5, when a view frustum 506 is displayed on the top-down map 208, the visualization client 116 may brighten, highlight, or enhance the points 508 on the top-down map falling within the frustum. This provides an indication to the user of the features and their locations on the top-down map 208 that are included in the photograph captured by the corresponding camera, referred to as the “coverage” of the camera. In another embodiment, all the points shown on the top-down map 208 may be brightened or highlighted in proportion to the number of photographs in which the corresponding feature is shown, representing the aggregated coverage of all the photographs in the visual reconstruction 112. This may be useful to a user for determining areas of particular interest to the photographer(s) contributing to the collection of photographs 104.

It will be appreciated that the visualization client 116 may display other reconstruction elements on the top-down map 208 beyond camera pose indicators 402, panorama indicators 404, object indicators 406, thumbnail images 504, and view frusta 506 described above and shown in the figures. For example, the visualization client 116 may show the path through the top-down map 208 from one camera position to the next when the user navigates from one photograph in the visual reconstruction 112 to another. This may help the user anticipate the transition between photographs. The visualization client 116 may also display the most recent actions taken by the user in navigating the photographs in the visual reconstruction 112, initially displaying the action in bold and then fading it away over time, to produce an effect similar to a radar screen.

As described above, the top-down map 208 may be rendered by projecting all the points of the 3-D point cloud 108 into a two-dimensional plane, eliminating the Z-axis in a traditional Cartesian coordinate system. However, this simple projection may produce top-down maps 208 that are cluttered or contain a significant amount of “noise.” Noise is points in the 3-D point cloud 108 that result from errors in the reconstruction process or that may be outside the region of interest in the visual reconstruction 112, referred to as “outliers.” In further embodiments, the visualization service 110 may employ several filtering and enhancement techniques when generating the top-down map 208 from the 3-D point cloud 108 to reduce the noise and enhance the top-down visualization, resulting in a more informative top-down map. The resulting top-down map 208 may consist of a filtered set of points from the 3-D point cloud with optional metadata, such as extracted edges, lines, or other enhancements.

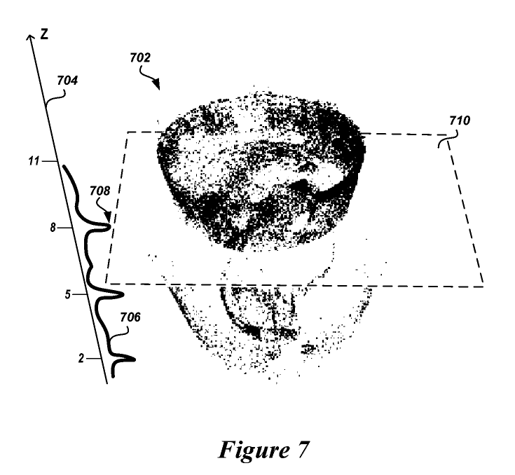

FIG. 7 shows a perspective view 702 of a 3-D point cloud 108 that may be generated from a collection of photographs 104 of a structure with multiple floors. According to one embodiment, the top-down map 208 generated by the visualization service 110 from this 3-D point cloud 108 may be filtered to only show points located on one floor of the multi-floor structure. To find points located on a single floor, the visualization service 110 takes advantage of the fact that the “up” direction of the 3-D point cloud 108, shown as the Z-axis 704 in the figure, may be known. The up direction may be calculated from the reconstruction itself by assuming that the majority of photographs in the collection of photographs 104 are oriented with the top of the photograph in the up direction, for example. Or, the up direction may be determined from metadata included with the photographs, such as external sensor data generated from a camera's accelerometer. In a further embodiment, the up direction may also be determined from the camera positions corresponding to the photographs in the collection of photographs 104, such as when the photographs are all taken by a photographer of a fixed height.

The visualization service 110 may project every point in the 3-D point cloud 108 onto a one-dimensional histogram 706 along the Z-axis 704. Because many points may exist on the ground of each floor, the resulting histogram 706 will produce spikes, such as the spike 708, at the point along the Z-axis 704 where each floor, such as the floor 710, is positioned. The visualization service 110 may utilize the spikes 708 in the histogram to determine the position of the floors 710 in the multi-floor structure, and only include the points from the 3-D point cloud 108 lying between two successive floors in the generation of the top-down map 208.

Alternatively, the visualization service 110 may examine the point normals of the points in the 3-D point cloud 108 to determine the position of the floors 710. The points in the 3-D point cloud generally lie on surfaces in the photographed scene or structure, and the point normals describe the orientation of the surface upon which the points lie. The point normals may be computed from the collection of photographs 104 during the image matching process, or the point normals may be computed using a coarse triangulation of the points in the 3-D point cloud 108.

Once the point normals are computed, the visualization service 110 may use the direction of the point normals to determine whether a point lies on horizontal surface, such as a floor 710. The visualization service 110 may further use a voting procedure to determine which points on horizontal surfaces represent floors 710, and which may represent other objects, like tables. It will be appreciated that other methods beyond those described herein may be utilized by the visualization service 110 to determine the position of floors in the 3-D point cloud 108 and to filter the points to only include those located within a single floor. It is intended that this application cover all such methods of filtering the points of a 3-D point cloud.

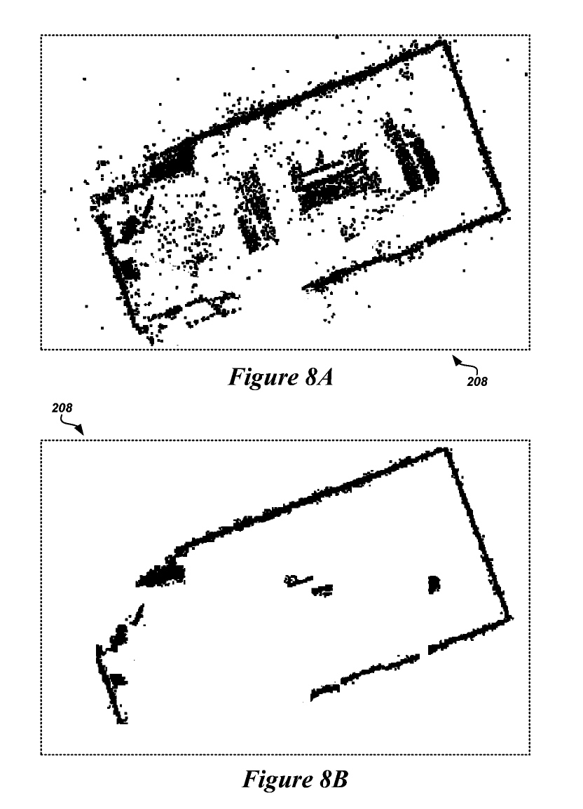

In another embodiment, the visualization service 110 may further filter the points in the 3-D point cloud 108 to remove the points that do not correspond to a wall of the structure represented in the visual reconstruction 112. This may be an important filter for interior reconstructions, where the walls provide important visual cues for the space of the scene when viewed in the top-down map 208. The visualization service 110 may use a density-thresholding technique for determining the position of the walls in the 3-D point cloud 108, for example. In this technique, the visualization service 110 projects all the points in the 3-D point cloud 108 onto a horizontal two-dimensional plane representing the floor. Because all the points belonging to a wall will project down to a small area, the wall will be represented by a dense region of points in the resulting top-down map 208, as shown in FIG. 8A. Points that do not belong to walls will project to a larger area, thus being sparse on the two-dimensional plane.

The visualization service 110 may compute the densities for the various regions of points and compare the computed densities to a threshold value. All points in regions below the threshold density value may then be removed from the top-down map 208, as shown in FIG. 8B. However, the density-thresholding technique can fail in the presence of objects. For example, a vase sitting on a table or the floor may project down as a dense region on the two-dimensional plane. To overcome this problem, the visualization service 110 may use a Z-variance technique to determine the regions of points in the 3-D point cloud 108 that represent walls, according to another embodiment.

The Z-variance technique relies on the fact that the points lying on a wall with exhibit a large variance along the Z-axis, while points on an object will have a low variance. As in the density-thresholding technique, the visualization service 110 projects all the points in the 3-D point cloud 108 onto a horizontal two-dimensional plane representing the floor, for example. The visualization service 110 may then compute the Z-variance of the points in regions or “cells” of the two-dimensional plane. Those points projected into cells with high Z-variance may be determined to lie on a wall and may be kept in the top-down map 208, while those points in cells with low Z-variance may be discarded.

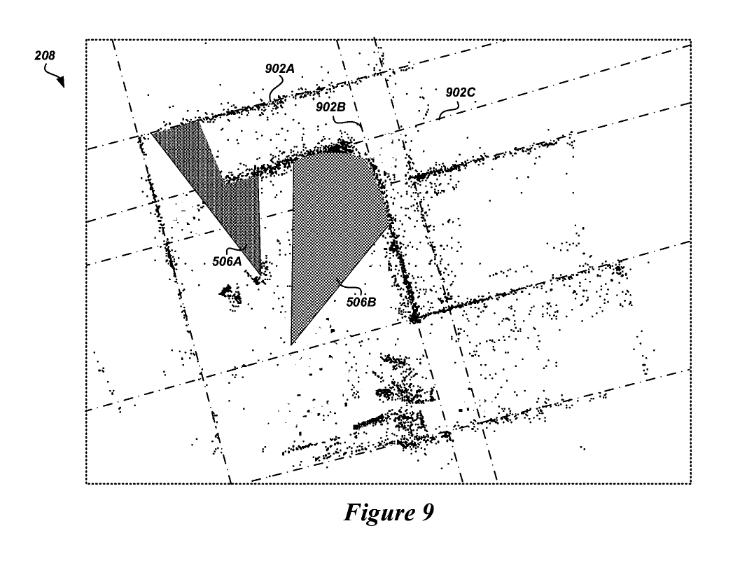

After filtering the 3-D point cloud 108 to remove outliers and other noise from the top-down map 208, the visualization service 110 may employ various enhancement techniques to further enhance the display of the top-down map 208. FIG. 9 shows a technique of enhancing the display of the top-down map 208 by detecting edges in the 3-D point cloud 108. The visualization service 110 may utilize a Hough transform on the points in the 3-D point cloud 108 and employ a voting procedure to determine a number of lines 902A-902D of infinite length from the point cloud. These lines may represent the locations of walls and other edges in the structure represented in the visual reconstruction 112.

The visualization service 110 may further use the visibility of points in various photographs to segment the lines 902A-902D at corners, hallways, doorways, and other open spaces in the 3-D point cloud 108. The visibility of a camera may be estimated by generating a polygon, represented in FIG. 9 by the view frusta 506A and 506B, from rays originating from the camera position to the points of the 3-D cloud 108 visible in the photograph. If a view frustum, such as view frustum 506A, crosses a line, such as line 902C, the visualization service 110 segments that line to further define the edge.

The segmented lines determined by this technique may be stored as metadata accompanying the visual reconstruction 112 provided to the visualization client 116, and may be utilized by the client in enhancing the display of the top-down map 208. For example, points that belong to a wall or other edge may be “splatted” with an ellipse 1002 that has an elongation along the direction of the line 902A-902D direction, as shown in FIG. 9. Since the point splats 1002 are forgiving to small errors, this technique allows for an enhanced display of the walls or other edges without the need for the identification of the edges to be highly accurate.

In another embodiment, the visualization service 110 uses the Z-values of the points as a hint to the point splatting, as well. The higher the Z-value of the point, the more splatting of the point that will occur. This further enhances the display of the wall or edge since the points belonging to walls will be more pronounced due to their maximum height. Additionally, the visualization client 116 or visualization service 110 may utilize the edge metadata to auto-orient the top-down map 208 in the visual reconstruction by examining the edges and finding the vanishing points to those edges.

It will be appreciated that the visualization service 110 may utilize other techniques to filter and enhance the 3-D point cloud 108 in generating and displaying the top-down map 208, beyond those described herein. For example, the visualization service may color the dots representing points in the top-down map 208 based on color information from the photographs containing the corresponding features. In another example, the visualization service 110 may utilize the density-thresholding and/or a Z-variance techniques described above to identify other objects on the top-down map 208 beyond walls. For instance, areas of high point density and low Z-Variance that are not located on a floor may represent a table or chair. The identification of these objects may be included in the metadata that is part of the visual reconstruction 112.

The visualization service 110 may further be able to recognize types of objects in the 3-D point cloud based on their two-dimensional or 3-D shape, such as a table, sink, or toilet. Based on the combinations of objects found in certain areas of the top-down map 208, distinguished by the identification of walls and/or doorways, for example, the visualization service 110 may further identify semantic areas within the top-down map 208. For instance, a particular area containing a sink and a table may be designated a kitchen, while an area containing a sink and a toilet may be designated a bathroom. The identification and dimensions of these semantic areas may further be included in the metadata delivered with the visual reconstruction 112.

In addition, various of the filtering and enhancing techniques described above may be utilized by the visualization service 110 to produce top-down maps 208 with specific themes or styles. For example, top-down maps 208 may be generated to resemble hand-drawn floorplans or chalkboard drawings. This may allow the top-down maps 208 to be visually compatible with different visualization clients 116 and/or different types of visual reconstructions 112. The themes or styles may also enable more forgiveness in any filtering or enhancement errors since the styles promote a more informal visualization.

In certain cases, multiple visual reconstructions 112 may be generated from a single collection of photographs 104, either due to disparate photographs of the same scene, or acquisitions of separate, nearby scenes in the photographs. However, the relative registration between two disparate visual reconstructions 112 may be weak. For example, in two visual reconstructions 112 of the interior of a house, one of a kitchen and the other of a hallway, the two scenes may only be linked together by a single photograph, such as a photograph of the kitchen from the hallway, or vice versa.

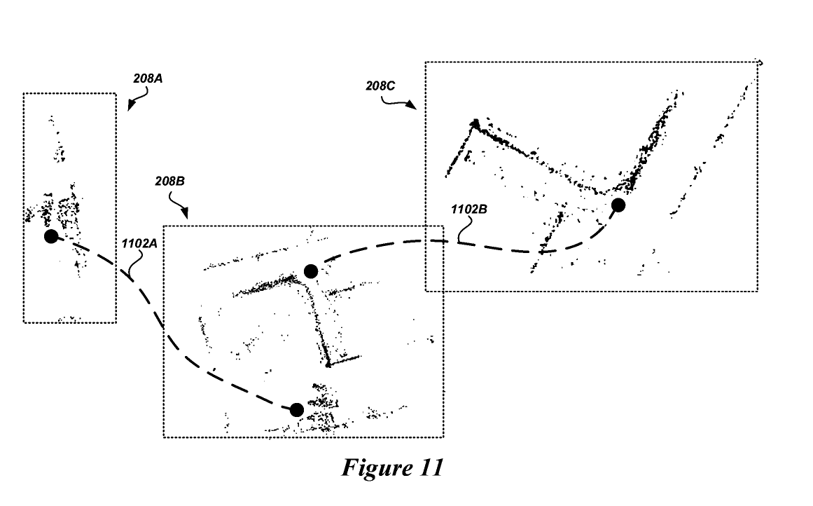

In this case, the visualization service 110 may not be able to determine the relative scale or orientation of the 3-D point cloud s108 computed from each reconstruction, preventing the generation of a single top-down map 208 with which to visualize the multiple reconstructions 112. According to one embodiment, the visualization service 110 generates separate top-down maps 208A-20C for each of the multiple visual reconstructions 112, which are then displayed by the visualization client 116 as separate “islands” in a single display, such as that shown in FIG. 11. This may help the user understand the context of nearby scenes. In a further embodiment, any links between the separate top-down maps 208A-208C identified by the visualization service 110 may be displayed as lines 1102A-1102B, arrows, or other visual indicators, as is further shown in FIG. 11.

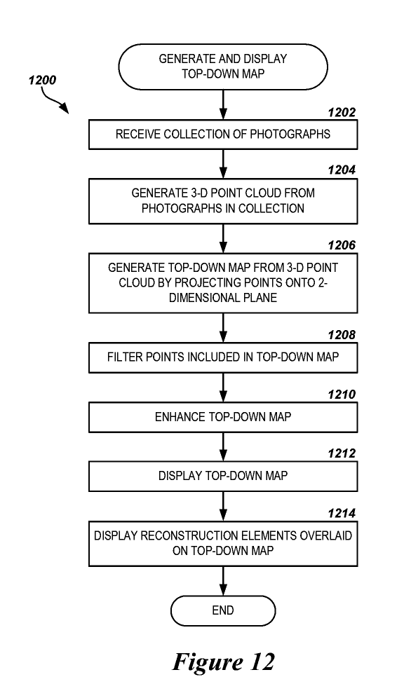

Referring now to FIG. 12, additional details will be provided regarding the embodiments presented herein. It should be appreciated that the logical operations described with respect to FIG. 12 are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations may be performed than shown in the figures and described herein. The operations may also be performed in a different order than described.

FIG. 12 illustrate a routine 1200 for generating and displaying top-down maps of reconstructed structures, in the manner described above. According to embodiments, the routine 1200 may be performed by a combination of the spatial processing engine 106, visualization service 110, and visualization client 116 described above in regard to FIG. 1. It will be appreciated that the routine 1200 may also be performed by other modules or components executing on the server computer 102 and/or user computer 118, or by any combination of modules and components.

The routine 1200 begins at operation 1202, where the visualization service 110 receives a collection of photographs 104. The collection of photographs 104 may be received from a user uploading two or more photographs taken of a particular structure or scene, or the collection of photographs may be an aggregation of photographs taken by multiple photographers of the same scene, for example.

From operation 1202, the routine 1200 proceeds to operation 1204, where the spatial processing engine 106 generates a 3-D point cloud 108 from the received collection of photographs 104. As described above, the spatial processing engine 106 may generate the 3-D point cloud 108 by locating recognizable features, such as objects or edges, that appear in two or more photographs in the collection of photographs 104, and calculating the position of the feature in space using the location, perspective, and visibility or obscurity of the features in each photograph. According to one embodiment, the spatial processing engine 106 generates the 3-D point cloud 108 from the collection of photographs 104 using a process such as that described in U.S. Patent Publication No. 2007/0110338 filed on Jul. 25, 2006, and entitled “Navigating Images Using Image Based Geometric Alignment and Object Based Controls,” which is incorporated herein by reference in its entirety.

The routine 1200 proceeds from operation 1204 to operation 1206, where the visualization service 110 generates a top-down map 208 for the visual reconstruction 112 from the 3-D point cloud 108. As described above, the top-down map 208 may be generated by projecting all the points of the 3-D point cloud 108 onto a horizontal two-dimensional plane, eliminating the Z-axis in a traditional Cartesian coordinate system. In one embodiment, the top-down map 208 is rendered using a perspective projection of the 3-D point cloud from the point-of-view of the center of the top-down map. In another embodiment, the top-down map 208 is rendered using an orthographic projection, like that found in many cartographical maps.

From operation 1206, the routine 1200 proceeds to operation 1208, where the visualization service 110 filters the points of the 3-D point cloud 108 included in the top-down map 208 to eliminate noise, reduce outliers, and enhance the visualization of the map. As described above, the visualization service 110 may apply a density-thresholding technique and/or a Z-variance technique to filter the points of the 3-D point cloud 108 for inclusion in the top-down map 208. It will be appreciated that the visualization service 110 may additionally or alternatively apply filtering techniques beyond those described herein to filter the points of the 3-D point cloud 108.

The routine 1200 proceeds from operation 1208 to operation 1210, where the visualization service 110 employs various enhancement techniques to further enhance the display of the top-down map 208. As described above, the visualization service 110 may apply edge detection techniques to identify walls and other edges in the top-down map 208. The location of the walls and edges may be stored in metadata that is sent with the visual reconstruction 112 to the visualization client 116. The visualization client 116 may utilize the metadata to enhance the display of the top-down map 208. In addition, the visualization service 110 may employ a point splatting technique to further enhance the display of the top-down map 208. It will be appreciated that visualization client 116 and/or visualization service 110 may additionally or alternatively apply enhancement techniques beyond those described herein to enhance the display of the top-down map 208.

From operation 1210, the routine 1200 proceeds to operation 1212, where the visualization client 116 displays the top-down map 208 on a display device 120 connected to the user computer 118. The top-down map 208 may be displayed in a split-screen view, where the map and local-navigation display 204 are both displayed in the window 202 at the same time, such as the mini-map 210 shown in FIG. 2. Alternatively, the top-down map 208 may be displayed in a modal view, as shown in FIG. 3. The visualization client 116 may further provide a user interface to allow the user to navigate the top-down map 208 and transition between the map and the local-navigation display 204, as described above.

The routine 1200 proceeds from operation 1212 to operation 1214, where the visualization client 116 may display reconstruction elements included in the visual reconstruction 112 overlaid on the top-down map 208. The reconstruction elements may include, but are not limited to, camera pose indicators 402, panorama indicators 404, object indicators 406, thumbnail images 504, and view frusta 506, each of which are described above and shown in the figures. The types and number of elements to display may depend on the view of the top-down map 208 displayed, the type of visual reconstruction 112 received by the visualization client 116, user specified preferences, and the like. The visualization client 116 may further add and remove reconstruction elements as the user interacts with the top-down map 208 or local-navigation display 204. From operation 1214, the routine 1200 ends.

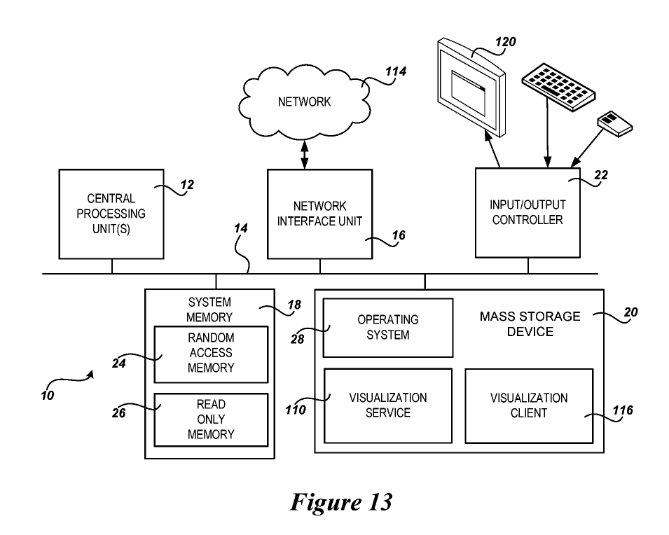

FIG. 13 shows an example computer architecture for a computer 10 capable of executing the software components described herein for generating and displaying top-down maps of reconstructed structures, in the manner presented above. The computer architecture shown in FIG. 13 illustrates a conventional computing device, PDA, digital cellular phone, communication device, desktop computer, laptop, or server computer, and may be utilized to execute any aspects of the software components presented herein described as executing on the user computer 118, server computer 102, or other computing platform.

The computer architecture shown in FIG. 13 includes one or more central processing units (“CPUs”) 12. The CPUs 12 may be standard central processors that perform the arithmetic and logical operations necessary for the operation of the computer 10. The CPUs 12 perform the necessary operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and other logic elements.

The computer architecture further includes a system memory 18, including a random access memory (“RAM”) 24 and a read-only memory 26 (“ROM”), and a system bus 14 that couples the memory to the CPUs 12. A basic input/output system containing the basic routines that help to transfer information between elements within the computer 10, such as during startup, is stored in the ROM 26. The computer 10 also includes a mass storage device 20 for storing an operating system 28, application programs, and other program modules, which are described in greater detail herein.

The mass storage device 20 is connected to the CPUs 12 through a mass storage controller (not shown) connected to the bus 14. The mass storage device 20 provides non-volatile storage for the computer 10. The computer 10 may store information on the mass storage device 20 by transforming the physical state of the device to reflect the information being stored. The specific transformation of physical state may depend on various factors, in different implementations of this description. Examples of such factors may include, but are not limited to, the technology used to implement the mass storage device, whether the mass storage device is characterized as primary or secondary storage, and the like.

For example, the computer 10 may store information to the mass storage device 20 by issuing instructions to the mass storage controller to alter the magnetic characteristics of a particular location within a magnetic disk drive, the reflective or refractive characteristics of a particular location in an optical storage device, or the electrical characteristics of a particular capacitor, transistor, or other discrete component in a solid-state storage device. Other transformations of physical media are possible without departing from the scope and spirit of the present description. The computer 10 may further read information from the mass storage device 20 by detecting the physical states or characteristics of one or more particular locations within the mass storage device.

As mentioned briefly above, a number of program modules and data files may be stored in the mass storage device 20 and RAM 24 of the computer 10, including an operating system 28 suitable for controlling the operation of a computer. The mass storage device 20 and RAM 24 may also store one or more program modules. In particular, the mass storage device 20 and the RAM 24 may store the visualization service 110 and visualization client 116, both of which were described in detail above in regard to FIG. 1. The mass storage device 20 and the RAM 24 may also store other types of program modules or data.

In addition to the mass storage device 20 described above, the computer 10 may have access to other computer-readable media to store and retrieve information, such as program modules, data structures, or other data. By way of example, and not limitation, computer-readable media may include volatile and non-volatile, removable and non-removable media implemented in any method or technology for storage of information such as computer-readable instructions, data structures, program modules, or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium that can be used to store the desired information and that can be accessed by the computer 10.

The computer-readable storage medium may be encoded with computer-executable instructions that, when loaded into the computer 10, may transform the computer system from a general-purpose computing system into a special-purpose computer capable of implementing the embodiments described herein. The computer-executable instructions may be encoded on the computer-readable storage medium by altering the electrical, optical, magnetic, or other physical characteristics of particular locations within the media. These computer-executable instructions transform the computer 10 by specifying how the CPUs 12 transition between states, as described above. According to one embodiment, the computer 10 may have access to computer-readable storage media storing computer-executable instructions that, when executed by the computer, perform the routine 1200 for generating and displaying a top-down map of a reconstructed structure or scene, described above in regard to FIG. 12.

According to various embodiments, the computer 10 may operate in a networked environment using logical connections to remote computing devices and computer systems through a network 114. The computer 10 may connect to the network 114 through a network interface unit 16 connected to the bus 14. It should be appreciated that the network interface unit 16 may also be utilized to connect to other types of networks and remote computer systems.

The computer 10 may also include an input/output controller 22 for receiving and processing input from a number of input devices, including a keyboard, a mouse, a touchpad, a touch screen, an electronic stylus, or other type of input device. Similarly, the input/output controller 22 may provide output to a display device 120, such as a computer monitor, a flat-panel display, a digital projector, a printer, a plotter, or other type of output device. It will be appreciated that the computer 10 may not include all of the components shown in FIG. 13, may include other components that are not explicitly shown in FIG. 13, or may utilize an architecture completely different than that shown in FIG. 13.

Based on the foregoing, it should be appreciated that technologies for generating and displaying top-down maps of reconstructed structures are provided herein. Although the subject matter presented herein has been described in language specific to computer structural features, methodological acts, and computer-readable media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-readable storage medium containing computer-executable instructions that, when executed by one or more computers, cause the computers to:
generate a top-down map from a 3-D point cloud computed from a collection of digital photographs by projecting points of the 3-D point cloud onto a horizontal two-dimensional plane; and
display the top-down map to a user of the computers.

2. The computer-readable storage medium of claim 1, wherein generating the top-down map from the 3-D point cloud further comprises filtering the points of the 3-D point cloud included in the top-down map.

3. The computer-readable storage medium of claim 1, wherein generating the top-down map from the 3-D point cloud further comprises enhancing the top-down map to emphasize walls or edges.

4. The computer-readable storage medium of claim 1, wherein the top-down map is displayed in a split-screen view in conjunction with a local-navigation display regarding the collection of digital photographs.

5. The computer-readable storage medium of claim 1, wherein displaying the top-down map further comprises displaying one or more reconstruction elements overlaid on the top-down map.

6. The computer-readable storage medium of claim 5, wherein the one or more reconstruction elements comprise one or more of camera poses, panoramas, objects, thumbnail images, and view frusta.

7. The computer-readable storage medium of claim 1, wherein a thumbnail image generated from a photograph in the collection of digital photographs and an associated view frustum are displayed overlaid on the top-down map in response to a user moving a selection control in proximity to one or more points in the top-down map that correspond to features visible in the photograph.

8. The computer-readable storage medium of claim 1, wherein a plurality of top-down maps corresponding to a plurality of separate 3-D points clouds generated from the collection of digital photographs are displayed together.

9. The computer-readable storage medium of claim 1, wherein generating the top-down map from the 3-D point cloud further comprises identifying one or more semantic areas within the top-down map based on a type of object identified in the 3-D point cloud.

10. A computer-implemented method for generating and displaying a top-down map of a structure or scene reconstructed from a collection of digital photographs, the method comprising:
generating the top-down map from a 3-D point cloud computed from the collection of digital photographs by projecting points of the 3-D point cloud onto a horizontal two-dimensional plane; and
displaying the top-down map to a user of the computer.

11. The method of claim 10, wherein generating the top-down map from the 3-D point cloud further comprises filtering the points of the 3-D point cloud included in the top-down map.

12. The method of claim 10, wherein generating the top-down map from the 3-D point cloud further comprises enhancing the top-down map to emphasize walls or edges.

13. The method of claim 10, wherein displaying the top-down map further comprises displaying one or more reconstruction elements overlaid on the top-down map.

14. The method of claim 13, wherein the one or more reconstruction elements comprise one or more of camera poses, panoramas, objects, thumbnail images, and view frusta.

15. The method of claim 10, wherein a thumbnail image generated from a photograph in the collection of digital photographs and an associated view frustum are displayed overlaid on the top-down map in response to a user of the computer moving a selection control in proximity to one or more points in the top-down map that correspond to features visible in the photograph.

16. A system for generating and displaying a top-down map of a structure or scene reconstructed from a collection of digital photographs, the system comprising:
a visualization service executing on a server computer and configured to:
generate the top-down map from a 3-D point cloud computed from the collection of digital photographs by projecting points in the 3-D point cloud onto a horizontal two-dimensional plane,
filter and enhance the points in the projection to enhance the display of the top-down map, and
send the top-down map to a user computer as part of a visual reconstruction; and
a visualization client executing on the user computer and configured to receive the visual reconstruction and display the top-down map on a display device connected to the user computer.

17. The system of claim 16, wherein the visualization client is configured to display the top-down map in a split-screen view in conjunction with a local-navigation display of the visual reconstruction.

18. The system of claim 16, wherein the visual reconstruction further comprises one or more reconstruction elements and the visualization client is further configured to display the one or more reconstruction elements overlaid on the top-down map.

19. The system of claim 16, wherein the visualization client is further configured to display a thumbnail image generated from a photograph in the collection of digital photographs and an associated view frustum overlaid on the top-down map in response to a user moving a selection control in proximity to one or more points in the top-down map that correspond to features visible in the photograph.

20. The system of claim 16, wherein the visualization client is further configured to display a plurality of top-down maps corresponding to a plurality of separate but related visual reconstructions together on the display device.
